(19) United States
(12) Patent Application Publication
(10) Pub. No.: US 2021/0340293 A1
(43) Pub. Date: Nov. 4, 2021

(54) TIRE

(71) Applicant: COMPAGNIE GENERALE DES ETABLISSEMENTS MICHELIN, Clermont-Ferrand (FR)

(72) Inventors: José-Carlos ARAUJO DA SILVA, Clermont-Ferrand Cedex 9 (FR); Aurore CROCHET, Clermont-Ferrand Cedex 9 (FR); Aurélie TRIGUEL, Clermont-Ferrand Cedex 9 (FR); Frédéric LEMERLE, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 17/271,970

(22) PCT Filed: Sep. 11, 2019
(86) PCT No.: PCT/FR2019/052097

§ 371 Date: Feb. 26, 2021

(30) Foreign Application Priority Data
Sep. 11, 2018 (FR) FR1858135

(51) Int. Cl. C08F 210/02; C08K 3/04; C08K 3/36; C08K 5/44; C08K 5/40; C08K 13/02; B60C 1/00

(52) U.S. Cl. CPC C08F 210/02; C08K 3/04; C08K 3/36; C08K 5/44; C08K 2201/014; C08K 13/02; B60C 1/0016; C08F 2800/10; C08K 5/40

(57) ABSTRACT

A tire whose tread consists totally or partly of a rubber composition which comprises at least 80 phr of a copolymer of ethylene and of a 1,3-diene which contains at least 70 mol % of ethylene units, between 25 phr and 55 phr of a carbon black, less than 1 phr of sulfur and a vulcanization accelerator is provided. The carbon black representing more than 60% by mass of the reinforcing filler of the rubber composition, the mass ratio between the sulfur content and the amount of vulcanization accelerator in the rubber composition being less than 1. The vulcanization accelerator is a primary accelerator or a mixture of a primary accelerator and of a secondary accelerator. Such a composition has good cohesion properties.

The field of the present invention is that of tyres whose tread consists totally or partly of a rubber composition rich in highly saturated diene elastomer.

It is known practice to use in rubber compositions for tyres copolymers with reduced oxidation sensitivity, for instance highly saturated diene elastomers, elastomers comprising ethylene units in a molar content of greater than 50 mol % of the monomer units of the elastomer. Mention may be made, for example, of copolymers of ethylene and of 1,3-diene which contain more than 50 mol % of ethylene, in particular copolymers of ethylene and of 1,3-butadiene. The use of such copolymers of ethylene and of 1,3-butadiene in a tyre tread is described, for example, in WO 2014/114607 A1 and has the effect of giving the tyre an improved compromise in terms of performance between the rolling resistance and the wear resistance.

It is also known practice to use such copolymers in tyre treads for aircraft to increase the high-speed wear resistance, as is described, for example, in WO 2016/012259 A1.

It is also important to have available tyres whose tread shows good cohesion. The reason for this is that during rolling, a tread is subjected to mechanical stresses and stress factors resulting from direct contact with the ground. As a consequence, crack initiation sites are created. During their propagation at the surface or inside the tread, the crack initiation sites may lead to the rupture of the material which constitutes the tread. This tread damage reduces the service life of the tyre tread. Since the mechanical stresses and stress factors to which the tyre is subjected are amplified under the effect of the weight borne by the tyre, good cohesion is most particularly sought in the case of a tyre mounted on a vehicle carrying heavy loads.

There is thus still concern to even further improve the performance of a tyre, notably to improve the cohesion of its tread consisting totally or partly of a rubber composition which very predominantly contains a copolymer of ethylene and of a 1,3-diene which is itself very rich in ethylene.

The Applicant has found a tyre which can meet this concern.

Thus, a first subject of the invention is a tyre which comprises a tread, of which the portion intended to be in contact with the rolling ground consists totally or partly of a rubber composition based at least on a highly saturated diene elastomer, a reinforcing filler which comprises a carbon black and a vulcanizing system comprising sulfur and a vulcanization accelerator,
the highly saturated diene elastomer being a copolymer of ethylene and of a 1,3-diene containing ethylene units which represent at least 70 mol % of the monomer units of the copolymer,
the content of the highly saturated diene elastomer in the rubber composition being at least 80 phr,
the carbon black in the rubber composition representing more than 60% by mass of the reinforcing filler,
the content of carbon black in the rubber composition being between 25 phr and 55 phr,
the content of sulfur in the rubber composition being less than 1 phr,
the mass ratio between the sulfur content and the amount of vulcanization accelerator in the rubber composition being less than 1,
the vulcanization accelerator being a primary accelerator or a mixture of a primary accelerator and of a secondary accelerator,
the mass ratio being calculated from the contents and amount expressed in phr.

### I. DETAILED DESCRIPTION OF THE INVENTION

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b). The abbreviation “phr” means parts by weight per hundred parts of elastomer (rubber) (of the total of the elastomers if several elastomers are present).

In the present patent application, the mass ratios between the various constituents of the rubber composition are calculated from the contents or amounts of the constituents expressed in phr.

In the present description, the expression “composition based on” should be understood as meaning a composition including the mixture and/or the product of the in situ reaction of the various constituents used, some of these base constituents (for example the elastomer, the filler or the constituents of the vulcanizing system or other additive conventionally used in a rubber composition intended for the manufacture of a tyre) being liable or intended to react together, at least partly, during the various phases of manufacture of the composition intended for the manufacture of a tyre.

In the present patent application, the expression “all of the monomer units of the elastomer” or “the total amount of the monomer units of the elastomer” means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of all of the monomer units of the elastomer.

The compounds mentioned in the description may be of fossil or biobased origin. In the latter case, they may be partially or completely derived from biomass or may be obtained from renewable starting materials derived from biomass. Elastomers, plasticizers, fillers and the like are notably concerned.

The elastomer that is useful for the purposes of the invention is a highly saturated diene elastomer, which is preferably statistical, which comprises ethylene units resulting from the polymerization of ethylene. In a known manner, the term “ethylene unit” refers to the —(CH₂—CH₂)— unit resulting from the insertion of ethylene into the elastomer chain. The highly saturated diene elastomer is very rich in ethylene units, since the ethylene units represent at least 70 mol % of all of the monomer units of the elastomer.

Preferably, the highly saturated diene elastomer comprises from 75 mol % to less than 95 mol % of ethylene units. In other words, the ethylene units preferentially represent from 75 mol % to less than 95 mol % of all of the monomer units of the highly saturated diene elastomer. More preferentially, the highly saturated diene elastomer comprises between 75 mol % and 90 mol % of ethylene units, the molar percentage being calculated on the basis of all of the monomer units of the highly saturated diene elastomer.

Since the highly saturated diene elastomer is a copolymer of ethylene and of a 1,3-diene, it also comprises 1,3-diene units resulting from the polymerization of a 1,3-diene. In a known manner, the term “1,3-diene unit” refers to units resulting from the insertion of the 1,3-diene via a 1,4 addition, a 1,2 addition or a 3,4 addition in the case of isoprene. The 1,3-diene units are those, for example, of a 1,3-diene containing 4 to 12 carbon atoms, such as 1,3-butadiene, isoprene, 1,3-pentadiene or an aryl-1,3-butadiene. Preferably, the 1,3-diene is 1,3-butadiene.

According to a first embodiment of the invention, the highly saturated diene elastomer contains units of formula (I). The presence of a saturated 6-membered ring unit, 1,2-cyclohexanediyl, of formula (I) in the copolymer may result from a series of very specific insertions of ethylene and of 1,3-butadiene into the polymer chain during its growth.

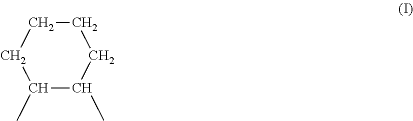

According to a second embodiment of the invention, the highly saturated diene elastomer contains units of formula (II).

—CH₂—CH(CH═CH₂)— (II)

According to a third embodiment of the invention, the highly saturated diene elastomer contains units of formula (I) and of formula (II).

According to a fourth embodiment of the invention, the highly saturated diene elastomer is free of units of formula (I). According to this fourth embodiment, the copolymer of ethylene and of a 1,3-diene preferably contains units of formula (II).

When the highly saturated diene elastomer comprises units of formula (I) or units of formula (II), the molar percentages of the units of formula (I) and of the units of formula (II) in the highly saturated diene elastomer, o and p respectively, preferably satisfy the following equation (eq. 1), more preferentially the equation (eq. 2), o and p being calculated on the basis of all of the monomer units of the highly saturated diene elastomer. These ranges of preferential values of o and p may apply to any of the embodiments of the invention, namely the first embodiment, the second embodiment, the third embodiment and the fourth embodiment, including the preferential variants thereof.

0<o+p≤25 (eq. 1)

0<o+p<20 (eq. 2)

According to the first embodiment, according to the second embodiment of the invention, according to the third embodiment and according to the fourth embodiment, including the preferential variants thereof, the highly saturated diene elastomer is preferentially a statistical copolymer.

The highly saturated diene elastomer that is useful for the purposes of the invention, in particular defined according to the first embodiment, according to the second embodiment, according to the third embodiment and according to the fourth embodiment, may be obtained according to various synthetic methods known to those skilled in the art, notably as a function of the targeted microstructure of the highly saturated diene elastomer. Generally, it may be prepared by copolymerization at least of a 1,3-diene, preferably 1,3-butadiene, and of ethylene and according to known synthetic methods, in particular in the presence of a catalytic system comprising a metallocene complex. Mention may be made in this respect of catalytic systems based on metallocene complexes, these catalytic systems being described in EP 1092 731, WO 2004/035639, WO 2007/054223 and WO 2007/054224 in the name of the Applicant. The highly saturated diene elastomer, including the case when it is statistical, may also be prepared via a process using a catalytic system of preformed type such as those described in WO 2017/093654 A1, WO 2018/020122 A1 and WO 2018/020123 A1.

The highly saturated diene elastomer that is useful for the purposes of the invention may consist of a mixture of highly saturated diene elastomers which differ from each other in their microstructures or in their macrostructures.

In the highly saturated diene elastomer defined according to the first embodiment of the invention, according to the second embodiment of the invention, according to the third embodiment and according to the fourth embodiment, the 1,3-diene is preferably 1,3-butadiene, in which case the highly saturated diene elastomer is a copolymer of ethylene and of 1,3-butadiene, which is preferably statistical.

According to the invention, the content of the highly saturated diene elastomer in the rubber composition is at least 80 parts by weight per hundred parts of elastomer (rubber) of the rubber composition (phr). Preferably, the content of the highly saturated diene elastomer in the rubber composition varies in a range extending from 80 to 100 phr. More preferentially, it varies in a range extending from 90 to 100 phr.

The vulcanizing system that is useful for the purposes of the invention has the essential characteristic of comprising sulfur and a vulcanization accelerator. By definition, the sulfur content and the amount of vulcanization accelerator in the vulcanizing system are strictly greater than 0 phr. Advantageously, the sulfur content in the rubber composition defined in any one of Claims 1 to 15 is greater than 0.3 phr. Advantageously, the amount of vulcanization accelerator in the rubber composition defined in any one of Claims 1 to 15, whether it is a primary accelerator or a mixture of a primary accelerator and of a secondary accelerator, is at least 0.5 phr.

The sulfur is typically provided in the form of molecular sulfur or of a sulfur-donating agent, preferably in molecular form. Sulfur in molecular form is also referred to by the term molecular sulfur. The term “sulfur donor” means any compound which releases sulfur atoms, optionally combined in the form of a polysulfide chain, which are capable of inserting into the polysulfide chains formed during the vulcanization and bridging the elastomer chains. According to the invention, sulfur is used in the rubber composition in a content of less than 1 phr and the mass ratio between the sulfur content and the amount of vulcanization accelerator in the rubber composition is less than 1. This twofold condition regarding the sulfur content and the mass ratio between the sulfur content and the amount of vulcanization accelerator combined with the very predominant use of a highly saturated diene elastomer in a rubber composition predominantly reinforced with carbon black makes it possible to significantly improve the cohesion of the rubber composition included in the tread portion, which is the portion intended to come into contact with the rolling ground.

According to a first alternative, the vulcanization accelerator is a primary accelerator, in which case the primary accelerator constitutes the only accelerator of the rubber composition. According to a second alternative, the vulcanization accelerator is a mixture of a primary accelerator and of a secondary accelerator, in which case the primary accelerator and the secondary accelerator constitute the only accelerators of the rubber composition. The term “primary accelerator” denotes a single primary accelerator or a mixture of primary accelerators. Similarly, the term “secondary accelerator” denotes a single secondary accelerator or a mixture of secondary accelerators.

When the vulcanization accelerator is a mixture of a primary accelerator and of a secondary accelerator, the secondary accelerator preferentially represents less than 50% by mass of the vulcanization accelerator, which amounts to saying that the mass ratio between the amount of the secondary accelerator and the amount of the vulcanization accelerator in the rubber composition is preferentially less than 0.5. More preferentially, the mass ratio between the amount of secondary accelerator and the amount of vulcanization accelerator in the rubber composition is preferentially less than or equal to 0.3.

When the vulcanization accelerator is a mixture of a primary accelerator and of a secondary accelerator, the mass ratio between the amount of secondary accelerator and the amount of vulcanization accelerator in the rubber composition defined in any one of Claims 1 to 15 is preferably greater than 0.05, more particularly between 0.05 and 0.7.

Use may be made, as (primary or secondary) vulcanization accelerator, of any compound that is capable of acting as accelerator of the vulcanization of diene elastomers in the presence of sulfur, notably accelerators of the thiazole type and also derivatives thereof, accelerators of sulfenamide type as regards the primary accelerators, or accelerators of thiuram, dithiocarbamate, dithiophosphate, thiourea and xanthate type as regards the secondary accelerators.

As examples of primary accelerators, mention may notably be made of sulfenamide compounds such as N-cyclohexyl-2-benzothiazylsulfenamide (“CBS”), N,N-dicyclohexyl-2-benzothiazylsulfenamide (“DCBS”), N-tert-butyl-2-benzothiazylsulfenamide (“TBBS”), and mixtures of these compounds. The primary accelerator is preferentially a sulfenamide, more preferentially N-cyclohexyl-2-benzothiazylsulfenamide.

As examples of secondary accelerators, mention may notably be made of thiuram disulfides such as tetraethylthiuram disulfide, tetrabutylthiuram disulfide (“TBTD”), tetrabenzylthiuram disulfide (“TBZTD”) and mixtures of these compounds. The secondary accelerator is preferentially a thiuram disulfide, more preferentially tetrabenzylthiuram disulfide.

When the vulcanization accelerator is a sulfenamide, it is preferably N-cyclohexyl-2-benzothiazylsulfenamide. When the vulcanization accelerator is a mixture of a primary accelerator and of a secondary accelerator, the vulcanization accelerator is preferably a mixture of a sulfenamide and of a thiuram disulfide, particularly a mixture of N-cyclohexyl-2-benzothiazylsulfenamide and of a thiuram disulfide, more particularly a mixture of N-cyclohexyl-2-benzothiazylsulfenamide and of tetrabenzylthiuram disulfide.

When the vulcanization accelerator is a mixture of a sulfenamide and of a thiuram disulfide, the mass ratio between the amount of secondary accelerator and the amount of vulcanization accelerator is preferentially less than 0.5, more preferentially less than or equal to 0.3.

When the vulcanization accelerator is a mixture of N-cyclohexyl-2-benzothiazylsulfenamide and of a thiuram disulfide, the mass ratio between the amount of secondary accelerator and the amount of vulcanization accelerator is preferentially less than 0.5, more preferentially less than or equal to 0.3.

When the vulcanization accelerator is a mixture of N-cyclohexyl-2-benzothiazylsulfenamide and of tetrabenzylthiuram disulfide, the mass ratio between the amount of secondary accelerator and the amount of vulcanization accelerator is preferentially less than 0.5, more preferentially less than or equal to 0.3.

Advantageously, the sulfur used is molecular sulfur and the vulcanization accelerator used is a sulfenamide such as N-cyclohexyl-2-benzothiazylsulfenamide or a mixture of a sulfenamide and of a thiuram disulfide, particularly a mixture of N-cyclohexyl-2-benzothiazylsulfenamide and of a thiuram disulfide, more particularly a mixture of N-cyclohexyl-2-benzothiazylsulfenamide and of tetrabenzylthiuram disulfide.

Preferably, the sulfur content in the rubber composition is less than 0.95 phr, preferably between 0.3 phr and 0.95 phr. Even more preferentially, the sulfur content in the rubber composition is less than 0.8 phr, preferably between 0.3 phr and 0.8 phr. These preferential ranges may apply most particularly when the sulfur is molecular sulfur. These preferential ranges may apply most particularly when the vulcanization accelerator is a sulfenamide such as N-cyclohexyl-2-benzothiazylsulfenamide or a mixture of a sulfenamide and of a thiuram disulfide such as a mixture of N-cyclohexyl-2-benzothiazylsulfenamide and of a thiuram disulfide or a mixture of N-cyclohexyl-2-benzothiazylsulfenamide and of tetrabenzylthiuram disulfide. These preferential ranges may apply most particularly when the sulfur is molecular sulfur and when the vulcanization accelerator is a sulfenamide such as N-cyclohexyl-2-benzothiazylsulfenamide or a mixture of a sulfenamide and of a thiuram disulfide such as a mixture of N-cyclohexyl-2-benzothiazylsulfenamide and of a thiuram disulfide or a mixture of N-cyclohexyl-2-benzothiazylsulfenamide and of tetrabenzylthiuram disulfide.

According to a first preferential variant, the mass ratio between the sulfur content and the amount of vulcanization accelerator is less than or equal to 0.7. This first variant may apply when the sulfur is molecular sulfur. This first variant may apply when the vulcanization accelerator is a sulfenamide such as N-cyclohexyl-2-benzothiazylsulfenamide or a mixture of a sulfenamide and of a thiuram disulfide, such as a mixture of N-cyclohexyl-2-benzothiazylsulfenamide and of a thiuram disulfide or a mixture of N-cyclohexyl-2-benzothiazylsulfenamide and of tetrabenzylthiuram disulfide. This first variant may apply when the sulfur is molecular sulfur and when the vulcanization accelerator is a sulfenamide such as N-cyclohexyl-2-benzothiazylsulfenamide or a mixture of a sulfenamide and of a thiuram disulfide, such as a mixture of N-cyclohexyl-2-benzothiazylsulfenamide and of a thiuram disulfide or a mixture of N-cyclohexyl-2-benzothiazylsulfenamide and of tetrabenzylthiuram disulfide.

According to a second more preferential variant, the mass ratio between the sulfur content and the amount of vulcanization accelerator is less than 0.6. This second variant may apply when the sulfur is molecular sulfur. This second variant may apply when the vulcanization accelerator is a sulfenamide such as N-cyclohexyl-2-benzothiazylsulfenamide or a mixture of a sulfenamide and of a thiuram disulfide, such as a mixture of N-cyclohexyl-2-benzothiazylsulfenamide and of a thiuram disulfide or a mixture of N-cyclohexyl-2-benzothiazylsulfenamide and of tetrabenzylthiuram disulfide. This second variant may apply when the sulfur is molecular sulfur and when the vulcanization accelerator is a sulfenamide such as N-cyclohexyl-2-benzothiazylsulfenamide or a mixture of a sulfenamide and of a thiuram disulfide, such as a mixture of N-cyclohexyl-2-benzothiazylsulfenamide and of a thiuram disulfide or a mixture of N-cyclohexyl-2-benzothiazylsulfenamide and of tetrabenzylthiuram disulfide.

In a known manner, the vulcanizing system may also comprise vulcanization activators, for instance metal oxides such as zinc oxide or fatty acids such as stearic acid.

The rubber composition that is useful for the purposes of the invention has the essential characteristic of comprising a reinforcing filler. The reinforcing filler may comprise any type of filler known for its capacities for reinforcing a rubber composition that may be used for the manufacture of tyres, for example an organic filler such as carbon black, an inorganic reinforcing filler such as silica which is associated, in a known manner, with a coupling agent, or else a mixture of these two types of filler. Such a reinforcing filler typically consists of nanoparticles whose mean (mass-average) size is less than a micrometre, generally less than 500 nm, usually between 20 and 200 nm, in particular and more preferentially between 20 and 150 nm.

The reinforcing filler that is useful for the purposes of the invention has the essential characteristic of comprising a carbon black. According to the invention, the carbon black in the rubber composition represents more than 60% by mass of the reinforcing filler, in other words said reinforcing filler comprises more than 60% by mass of carbon black relative to the total weight of reinforcing filler. According to the invention, the content of carbon black in the rubber composition is between 25 phr and 55 phr.

According to a particular embodiment of the invention, known as the fifth embodiment, the reinforcing filler comprises a silica. The silica used may be any reinforcing silica known to a person skilled in the art, in particular any precipitated or fumed silica with a BET specific surface area and also a CTAB specific surface area both of less than 450 m²/g, preferably in a range extending from 30 to 400 m²/g, notably from 60 to 300 m²/g. Use may be made of any type of precipitated silica, notably highly dispersible silicas (HDS). These precipitated silicas, which may or may not be highly dispersible, are well known to those skilled in the art. Mention may be made, for example, of the silicas described in patent applications WO 03/016215-A1 and WO 03/016387-A1. In the present specification, the BET specific surface area is determined in a known manner by gas adsorption using the Brunauer-Emmett-Teller method described in The Journal of the American Chemical Society, Vol. 60, page 309, February 1938, more specifically according to the French standard NF ISO 9277 of December 1996 (multipoint (5 point) volumetric method—gas: nitrogen—degassing: 1 hour at 160° C.—relative pressure p/po range: 0.05 to 0.17). The CTAB specific surface area is the external surface area determined according to the French standard NF T 45-007 of November 1987 (method B).

In order to couple the silica to the highly saturated diene elastomer, use may be made, in a known manner, of an at least difunctional coupling agent (or bonding agent) intended to provide a satisfactory connection, of chemical and/or physical nature, between the silica (surface of its particles) and the elastomer. Use is made in particular of at least difunctional organosilanes or polyorganosiloxanes. Preferentially, the organosilanes are chosen from the group consisting of organosilane polysulfides (symmetrical or asymmetrical) such as bis(3-triethoxysilylpropyl) tetrasulfide, abbreviated as TESPT, sold under the name Si69 by the company Evonik.

According to the fifth embodiment of the invention, the sulfur is preferentially molecular sulfur. According to the fifth embodiment of the invention, the vulcanization accelerator is preferably a sulfenamide such as N-cyclohexyl-2-benzothiazylsulfenamide or a mixture of a sulfenamide and of a thiuram disulfide, such as a mixture of N-cyclohexyl-2-benzothiazylsulfenamide and of a thiuram disulfide or a mixture of N-cyclohexyl-2-benzothiazylsulfenamide and of tetrabenzylthiuram disulfide. According to the fifth embodiment of the invention, the vulcanizing system more preferentially comprises molecular sulfur as sulfur and comprises as vulcanization accelerator a sulfenamide such as N-cyclohexyl-2-benzothiazylsulfenamide or a mixture of a sulfenamide and of a thiuram disulfide, such as a mixture of N-cyclohexyl-2-benzothiazylsulfenamide and of a thiuram disulfide, or a mixture of N-cyclohexyl-2-benzothiazylsulfenamide and of tetrabenzylthiuram disulfide. The preferential variants of the fifth embodiment may be combined with any of the embodiments, namely the first embodiment, the second embodiment, the third embodiment and the fourth embodiment.

According to another embodiment of the invention, known as the sixth embodiment, carbon black represents more than 85% by mass of the reinforcing filler, preferably 100% by mass of the reinforcing filler. When carbon black represents 100% by mass of the reinforcing filler, the reinforcing filler consists of carbon black.

According to the sixth embodiment of the invention, the sulfur is preferentially molecular sulfur. According to the sixth embodiment of the invention, the vulcanization accelerator is preferably a sulfenamide such as N-cyclohexyl-2-benzothiazylsulfenamide or a mixture of a sulfenamide and of a thiuram disulfide, such as a mixture of N-cyclohexyl-2-benzothiazylsulfenamide and of a thiuram disulfide or a mixture of N-cyclohexyl-2-benzothiazylsulfenamide and of tetrabenzylthiuram disulfide. According to the sixth embodiment of the invention, the vulcanizing system more preferentially comprises molecular sulfur as sulfur and comprises as vulcanization accelerator a sulfenamide such as N-cyclohexyl-2-benzothiazylsulfenamide or a mixture of a sulfenamide and of a thiuram disulfide, such as a mixture of N-cyclohexyl-2-benzothiazylsulfenamide and of a thiuram disulfide, or a mixture of N-cyclohexyl-2-benzothiazylsulfenamide and of tetrabenzylthiuram disulfide.

Any carbon black, notably the blacks conventionally used in tyres treads (known as tyre-grade blacks), is suitable for use as carbon blacks. The carbon blacks may be used in isolated form, as commercially available, or in any other form, for example as support for some of the rubber additives used. Mention may be made more particularly of the reinforcing carbon blacks of the 100, 200 and 300 series, or of the blacks of the 500, 600 or 700 series (ASTM grades).

Advantageously, in the rubber composition that is useful for the purposes of the invention, in particular defined in any one of Claims 1 to 15, the carbon black is a carbon black of the 100 or 200 series.

The rubber composition that is useful for the purposes of the invention may also include all or some of the usual additives customarily used in elastomer compositions intended to constitute treads, for instance processing agents, plasticizers, pigments, protective agents, such as antiozone waxes, chemical antiozonants or antioxidants.

According to one embodiment of the invention, known as the seventh embodiment, the rubber composition that is useful for the purposes of the invention, in particular defined in any one of Claims 1 to 15, is free of zinc diacrylate derivative in the form of a zinc salt of formula (III) in which R₁, R₂ and R₃ represent, independently of each other, a hydrogen atom or a C₁-C₇ hydrocarbon-based group chosen from linear, branched or cyclic alkyl groups, aralkyl groups, alkylaryl groups and aryl groups, and optionally interrupted with one or more heteroatoms, R₂ and R₃ together possibly forming a non-aromatic ring. The seventh embodiment may be combined with any of the embodiments of the invention, namely the first embodiment, the second embodiment, the third embodiment, the fourth embodiment, the fifth embodiment and the sixth embodiment, including the preferential variants thereof.

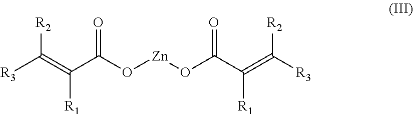

The rubber composition may be manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically below 110° C., for example between 40° C. and 100° C., during which finishing phase the sulfur or the sulfur donor and the vulcanization accelerator are incorporated.

By way of example, the first phase (non-productive) is performed as a single thermomechanical step during which all the necessary constituents, the optional additional processing agents and the other various additives, with the exception of the sulfur and the vulcanization accelerator, are introduced into a suitable mixer such as a conventional internal mixer. The total kneading time in this non-productive phase is preferably between 1 and 15 minutes. After cooling the mixture thus obtained during the first non-productive phase, the sulfur and the vulcanization accelerator are then incorporated at low temperature, generally into an external mixer such as an open mill; the whole is then mixed (productive phase) for a few minutes, for example between 2 and 15 minutes.

According to one embodiment, the rubber composition is extruded to form all or part of a tread profile of a tyre. Next, during the assembly of a tyre usually comprising, radially from the exterior to the interior, a tread, a crown reinforcement and a carcass reinforcement, the tread is placed radially to the exterior of the crown reinforcement. The term “radially” means, in a known manner, in a radial direction relative to the axis of rotation of the tyre.

The tyre may be in raw form (i.e. before the step of curing the tyre) or in cured form (i.e. after the step of curing the tyre). The tyre is preferentially a tyre for a vehicle intended to carry heavy loads, for instance heavy goods vehicles and civil engineering vehicles.

The abovementioned characteristics of the present invention, and also others, will be understood more clearly on reading the following description of several implementation examples of the invention, which are given as non-limiting illustrations.

### II. EXAMPLES OF IMPLEMENTATION OF THE INVENTION

II.1 Tests and Measurements:

II.1-1 Determination of the Microstructure of the Elastomers:

The microstructure of the elastomers is determined by 1H NMR analysis combined with ¹¹C NMR analysis when the resolution of the ¹H NMR spectra does not enable assignment and quantification of all the species. The measurements are performed using a Broker 500 MHz NMR spectrometer at frequencies of 500.43 MHz for proton observation and 125.83 MHz for carbon observation.

For the insoluble elastomers which have the capacity of swelling in a solvent, a 4 mm z-grad HRMAS probe is used for proton and carbon observation in proton-decoupled mode. The spectra are acquired at rotational speeds of from 4000 Hz to 5000 Hz.

For the measurements on soluble elastomers, a liquid NMR probe is used for proton and carbon observation in proton-decoupled mode.

The preparation of the insoluble samples is performed in rotors filled with the analysed material and a deuterated solvent enabling swelling, generally deuterated chloroform (CDCl3). The solvent used must always be deuterated and its chemical nature may be adapted by a person skilled in the art. The amounts of material used are adjusted so as to obtain spectra of sufficient sensitivity and resolution.

The soluble samples are dissolved in a deuterated solvent (about 25 mg of elastomer in 1 mL), generally deuterated chloroform (CDCl3). The solvent or solvent blend used must always be deuterated and its chemical nature may be adapted by a person skilled in the art.

In both cases (soluble sample or swollen sample):

A 30° single pulse sequence is used for proton NMR. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

A 30° single pulse sequence is used for carbon NMR, with proton decoupling only during the acquisition to avoid nuclear Overhauser effects (NOE) and to remain quantitative. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

The NMR measurements are performed at 25° C.

II. 1-2 Mechanical Strength in the Presence of a Crack Initiation Site (Tearability):

The tearability strength and deformation are measured on a specimen drawn at 500 mm/minute to bring about rupture of the specimen. The tensile test specimen consists of a parallelepiped-shaped rubber slab, for example with a thickness of between 1 and 2 mm, a length of between 130 and 170 mm and a width of between 10 and 15 mm, the two side edges each being covered lengthwise with a cylindrical rubber bead (diameter 5 mm) for anchoring in the jaws of the tensile testing machine. Three very fine notches between 15 and 20 mm long are made using a razor blade, at mid-length and aligned in the lengthwise direction of the specimen, one at each end and one at the centre of the specimen, before starting the test. The force (N/mm) to be exerted to obtain rupture is determined and the elongation at break is measured. The test was performed in air, at a temperature of 100° C. High values reflect good cohesion of the rubber composition although having crack initiation sites.

II.1-3 Tensile Tests:

The elongation at break (EB %) and breaking stress (BS) tests are based on the standard NF ISO 37 of December 2005 on an H2 dumbbell specimen and are measured at a traction speed of 500 mm/min. The elongation at break is expressed as a percentage of elongation. The breaking stress is expressed in MPa. All these tensile test measurements are performed at 60° C.

II.2 Preparation of the Rubber Compositions:

The rubber compositions, the details of the formulation of which are given in Table 1, were prepared in the following manner:

The elastomer, the reinforcing filler and the various other ingredients, with the exception of the sulfur and the vulcanization accelerator, are successively introduced into an internal mixer (final degree of filling: about 70% by volume), the initial vessel temperature of which is about 80° C. Thermomechanical working (non-productive phase) is then performed in one step, which lasts in total approximately 3 to 4 min, until a maximum “dropping” temperature of 165° C. is reached. The mixture thus obtained is recovered and cooled, and sulfur and the vulcanization accelerator are then incorporated on a mixer (homofinisher) at 30° C., the whole being kneaded (productive phase) for an appropriate time (for example approximately ten minutes).

The compositions thus obtained are subsequently calendered, either in the form of slabs (thickness of 2 to 3 mm) or of thin sheets of rubber, for measurement of their physical or mechanical properties, or extruded in the form of a tyre tread.

The elastomer (EBR) is prepared according to the following procedure: 30 mg of metallocene [{Me₂SiFlu₂Nd(μ-BH₄)₂Li(THF)}₂, the symbol Flu representing the fluorenyl group of formula C₁₃H₈], are introduced into a first Steinie bottle in a glovebox. The co-catalyst, butyloctylmagnesium dissolved beforehand in 300 ml of methylcyclohexane in a second Steinie bottle, is introduced into the first Steinie bottle containing the metallocene in the following proportions: 0.00007 mol/L of metallocene, 0.0004 mol/L of co-catalyst. After contact for 10 minutes at room temperature, a catalytic solution is obtained. The catalytic solution is then introduced into the polymerization reactor. The temperature in the reactor is then increased to 80° C. When this temperature is reached, the reaction starts by injection of a gaseous mixture of ethylene and 1,3-butadiene (80/20 mol %) into the reactor. The polymerization reaction proceeds at a pressure of 8 bar. The proportions of metallocene and of co-catalyst are, respectively, 0.00007 mol/L and 0.0004 mol/L. The polymerization reaction is stopped by cooling, degassing of the reactor and addition of ethanol. An antioxidant is added to the polymer solution. The copolymer is recovered by drying in a vacuum oven.

II.3 Results:

The results are given in Table 1.

The rubber compositions C1, C4, C5, C6, C7, C8, C9 and C10 in accordance with the invention, for which the sulfur content is less than 1 and the mass ratio between the sulfur content and the amount of vulcanization accelerator is less than 1, have elongation at break values that are much higher than those of the non-compliant rubber compositions, C2 and C3. Compositions C1, C4, C5, C6, C7, C8, C9 and C10 in accordance with the invention prove to be mechanically much stronger and more cohesive than compositions C2 and C3, whether or not in the presence of crack initiation sites.

Thus, a tyre has an improved service life if it includes a tread in which the portion intended to come into contact with the rolling ground consists totally or partly of compositions C1, C4, C5, C6, C7, C8, C9 and C10 in accordance with the invention rather than compositions C2 and C3.

TABLE 1

| Composition | C1 | C2 | C3 | C4 | C5 | C6 | C7 | C8 | C9 | C10 |
|---|---|---|---|---|---|---|---|---|---|---|
| EBR (1) | 100 | 100 | 100 | 100 | 100 | 100 | 100 | 100 | 100 | 100 |
| Carbon black (2) | 40 | 40 | 40 | 40 | 40 | 40 | 40 | 40 | 40 | 40 |
| Antioxidant (3) | 2 | 2 | 2 | 2 | 2 | 2 | 2 | 2 | 2 | 2 |
| Antiozone wax | 1 | 1 | 1 | 1 | 1 | 1 | 1 | 1 | 1 | 1 |
| Stearic acid | 1.5 | 1.5 | 1.5 | 1.5 | 1.5 | 1.5 | 1.5 | 1.5 | 1.5 | 1.5 |
| ZnO | 2.5 | 2.5 | 2.5 | 2.5 | 2.5 | 2.5 | 2.5 | 2.5 | 2.5 | 2.5 |
| Accelerator 1 (4) | 1.2 | 0.8 | 1.1 | 1.43 | 1.13 | 1.07 | 1.01 | 0.95 | 0.96 | 0.96 |
| Accelerator 2 (5) | — | — | — | — | 0.13 | 0.19 | 0.25 | 0.31 | 0.10 | 0.15 |
| Sulfur | 0.5 | 1.5 | 1.1 | 0.94 | 0.56 | 0.56 | 0.56 | 0.56 | 0.70 | 0.45 |
| Sulfur/Accelerator | 0.4 | 1.8 | 1 | 0.66 | 0.44 | 0.44 | 0.44 | 0.44 | 0.66 | 0.41 |
| Properties in cured form | | | | | | | | | | |
| Traction at 60° C. | | | | | | | | | | |
| Elongation at break (%) | 756 | 421 | 449 | 527 | 641 | 608 | 565 | 563 | 557 | 671 |
| Breaking stress (MPa) | 21 | 15 | 17 | 18 | 17 | 16 | 15 | 16 | 16 | 17 |
| Tearability at 100° C. | | | | | | | | | | |
| Elongation at break (%) | 316 | 58 | 70 | 98 | 206 | 159 | 126 | 95 | 116 | 306 |
| Breaking strength (N/mm) | 31 | 14 | 14 | 16 | 23 | 18 | 16 | 14 | 17 | 31 |

(1) Elastomer containing 79 mol % of ethylene units, 7 mol % of 1,2-cyclohexanediyl units, 8 mol % of 1,2 units of the butadiene part, and 6 mol % of 1,4 units of the butadiene part
(2) N234
(3) N-(1,3-Dimethylbutyl)-N′-phenyl-p-phenyenediamine (Santoflex 6-PPD from the company Flexsys)
(4) N-Cyclohexyl-2-benzothiazolesulfenamide (Santocure CBS from the company Flexsys)
(5) Tetrabenzylthiuram disulfide (Perkacit TBZTD from the company Flexsys)

1. A tire which comprises a tread, of which the portion intended to be in contact with the rolling ground consists totally or partly of a rubber composition based at least on a highly saturated diene elastomer, a reinforcing filler which comprises a carbon black and a vulcanizing system comprising sulfur and a vulcanization accelerator,
the highly saturated diene elastomer being a copolymer of ethylene and of a 1,3-diene containing ethylene units which represent at least 70 mol % of the monomer units of the copolymer,
the content of the highly saturated diene elastomer in the rubber composition being at least 80 phr,
the carbon black in the rubber composition representing more than 60% by mass of the reinforcing filler,
the content of carbon black in the rubber composition being between 25 phr and 55 phr,
the content of sulfur in the rubber composition being less than 1 phr,
the mass ratio between the sulfur content and the amount of vulcanization accelerator in the rubber composition being less than 1,
the vulcanization accelerator being a primary accelerator or a mixture of a primary accelerator and of a secondary accelerator,
the mass ratio being calculated from the contents and amount expressed in phr.

2. The tire according to claim 1, in which the highly saturated diene elastomer comprises from 75 mol % to less than 95 mol % of ethylene units.

3. The tire according to claim 1, in which the content of highly saturated diene elastomer in the rubber composition varies within a range extending from 80 to 100 phr.

4. The tire according to claim 1, in which the 1,3-diene is 1,3-butadiene.

5. The tire according to claim 1, in which the highly saturated diene elastomer contains units of formula (I) or units of formula (II), or else units of formula (I) and of formula (II).

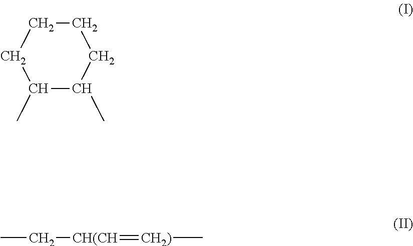

6. The tire according to claim 1, in which the highly saturated diene elastomer is statistical.

7. The tire according to claim 5, in which the molar percentages of the units of formula (I) and of the units of formula (II) in the highly saturated diene elastomer, o and p respectively, satisfy the following equation (eq. 1), o and p being calculated on the basis of all of the monomer units of the highly saturated diene elastomer
0<o+p≤25 (eq. 1).

8. The tire according to claim 1, in which the sulfur content in the rubber composition is less than 0.95 phr.

9. The tire according to claim 1, in which the sulfur content in the rubber composition is less than 0.8 phr.

10. The tire according to claim 1, in which the mass ratio between the sulfur content and the amount of vulcanization accelerator in the rubber composition is less than or equal to 0.7.

11. The tire according to claim 1, in which the primary accelerator is a sulfenamide.

12. The tire according to claim 1, in which the secondary accelerator is a thiuram disulfide.

13. The tire according to claim 1, in which the mass ratio between the amount of secondary accelerator and the amount of vulcanization accelerator in the rubber composition is less than 0.5, the mass ratio being calculated from the amounts expressed in phr.

14. The tire according to claim 1, in which the reinforcing filler comprises a silica.

15. The tire according to claim 1, in which carbon black represents more than 85% by mass of the reinforcing filler.

16. The tire according to claim 2, in which the highly saturated diene elastomer comprises between 75 mol % and 90 mol % of ethylene units.

17. The tire according to claim 3, in which the content of highly saturated diene elastomer in the rubber composition varies within a range extending from 90 to 100 phr.

18. The tire according to claim 5, in which the molar percentages of the units of formula (I) and of the units of formula (II) in the highly saturated diene elastomer, o and p respectively, satisfy the following equation (eq. 2), o and p being calculated on the basis of all of the monomer units of the highly saturated diene elastomer
0<o+p<20 (eq. 2).

19. The tire according to claim 8, in which the sulfur content in the rubber composition is between 0.3 phr and 0.95 phr.

20. The tire according to claim 9, in which the sulfur content in the rubber composition is between 0.3 phr and 0.8 phr.
